(19) United States
(12) Patent Application Publication
(10) Pub. No.: US 2016/0159477 A1
(43) Pub. Date: Jun. 9, 2016

(54) RESONANCE MOTOR DIRECT DRIVE FLAPPING WING MICRO AIR VEHICLE SYSTEM

(71) Applicant: PURDUE RESEARCH FOUNDATION, West Lafayette, IN (US)

(72) Inventors: Xinyan Deng, Lafayette, IN (US); Jian Zhang, Lafayette, IN (US)

(73) Assignee: PURDUE RESEARCH FOUNDATION, West Lafayette, IN (US)

(21) Appl. No.: 14/707,877

(22) Filed: May 8, 2015

Related U.S. Application Data
(60) Provisional application No. 61/991,438, filed on May 9, 2014.

(51) Int. Cl. B64C 33/02

(52) U.S. Cl. CPC B64C 33/025

(57) ABSTRACT

Presented herein are an actuation system and a flapping wing micro aerial vehicle system. In one embodiment, for energy efficiency and to achieve a resonant system, the flapping wing is directly driven using conventional DC motors coupled with torsion springs. Using a transmission gear, the motor is designed to operating at an efficient speed, but generates an overall reciprocal motion to the wing. Closed loop control is applied to achieve tracking of the desired wing motion kinematics, the frequency of which is tuned to match the resonant frequency of the system. We also show that wing kinematic control can be achieved by tracking trajectories with different amplitude and bias, therefore creating flight control forces and torques.

### CROSS-REFERENCE TO RELATED APPLICATIONS

The present U.S. patent application is related to and claims the priority benefit of U.S. Provisional Patent Application Ser. No. 61/991,438, filed May 9, 2014, the contents of which is hereby incorporated by reference in its entirety into this disclosure.

### STATEMENT OF GOVERNMENT INTEREST

This invention was made with government support under FA9550-11-1-0058 awarded by the Air Force Office of Scientific Research. The government has certain rights in the invention.

### TECHNICAL FIELD

The present disclosure generally relates to aerial vehicle systems, and in particular to flapping wing micro aerial vehicles and robotics.

### BACKGROUND

This section introduces aspects that may help facilitate a better understanding of the disclosure. Accordingly, these statements are to be read in this light and are not to be understood as admissions about what is or is not prior art.

In past decades, biologists have revealed the exceptional flight stability and maneuverability of flapping-wing insects, which have spawned great interest to develop flapping wing Micro Air vehicles (MAVs) or flapping wing robots. The efforts to date can be divided into two main categories: motor driven linkage and piezoelectric cantilever mechanisms. Piezoelectric cantilever mechanisms have been proven to be effective as a flapping actuator at sub-gram scales because of its high power density at high frequencies (using high voltage) and low transmission losses.

Motor driven actuators are successful at larger scales, operating at high efficiency and generating large output angles with low drive voltage. Linkage mechanisms are commonly used to transform rotational motion from the motor to reciprocal motion of the wings, which ensures the motor is able to operate at its efficient speed. However, they are also subjected to limitations such as fixed output kinematics without additional mechanisms, asymmetry in the kinematics without additional variable speed control, parasite structural vibration due to asymmetric acceleration and the linkage system operating at high frequency, and no elastic component in the system to preserve wing kinetic energy and therefore lower the efficiency. In the ideal scenario, with elastic components and system resonance, the kinetic and potential energy of the mechanical components in the system are conserved, and therefore, all the power is spent on the non-conservative energy cost, such as friction, damping of the system and the aerodynamic damping acting on the wing. Several modifications to the linkage system have been proposed and tested in previous studies that result in efficiency improvements. For example, an elastic component was introduced to achieve resonance of a motor driven slider-crank mechanism. In the Nanohummingbird, the linkage was replaced by strings with negligible mass, therefore, reduced the inertial loss on transmission and the parasite structural vibrations.

From the wing aerodynamic force control point of view, flapping wing MAV platform to date can be divided into two main categories: direct-drive type and linkage type, etc. Compared to the direct-drive type, the linkage type is often subjected to force control limitations such as fixed output kinematics without additional mechanisms and asymmetry in the kinematics without additional variable speed control. The force control can only be achieved through additional angle-of-attack servo control mechanism. But in the meantime, they offer the advantage that the kinematics will be robustly fixed if a speed controller is used. As for the direct drive type, certain works are devoted to solve its kinematic and force control problem. Due to size limitation of a feedback sensor at sub-gram scale, uses the open loop feed forward method; with excellent modelling, the control results are demonstrated to be satisfactory. As our system is hummingbird-size, a small magnetic encoder (1 mm*1 mm) is used for wing trajectory feedback. So far, no effort has been attempted to wing kinematics and force control under influence of uncertainties, especially uncertain nonlinearities and parametric uncertainties.

The relative impact of uncertainties to the small-scale flapping wing MAV (FWMAV) is substantially larger than the traditional larger-scale aerial vehicle. The unknown and unexpected disturbances can be of various forms, such as wind gust, rain drops, obstacles, etc. But the insect/hummingbird can handle those disturbances and achieve recovery with ease. So the robustness issues, especially the problem of disturbance rejection, uncertainty attenuation and fault tolerance of the flapping wing system need further investigation. And this problem should be addressed later in the context of complete body and flapping wing dynamics and control.

Inspired also by natural flyer's ability to adapt to the changing system parameters, such as changes of the wing size and weight, injury, aging, variations of air density due to altitude elevation, and wind conditions, the adaptability of FWMAV should also be explored in order to fill the gap of high performance, especially adaptability and robustness.

In addition, manufacturing imperfection and high frequency oscillation induced wear and damage also cause many variations and uncertainties to the system. Therefore, there is an unmet need for an aerial vehicle system that is efficient, reliable long-lasting, and provides advanced control.

### SUMMARY

Presented herein is an actuation system. In one embodiment, the actuation system has a direct current motor, a motor encoder, and a torsional spring. In some aspects, the motor encoder provides position feedback for the motor. The torsional spring is coupled to the motor to restore the energy of the back-and-forth flapping wing and motor motion.

Also presented herein is a vehicle system. In one embodiment, the vehicle system has a vehicle frame, a rotor that is disposed within the vehicle frame and configured to have direct rotational oscillation about a rotation axis following a predetermined rotational arc having a middle position and operatively within a predetermined oscillation frequency range, at least one restoring element that is configured to provide a net counter torque to the rotor to bias the rotor to rotate to the middle position, where the net counter torque is its minimum with the rotor's rotational position corresponds to the middle position, at least two motors, positioned within the vehicle frame, an onboard electronic system, the onboard electronic system has an inertial measurement unit, microcontrollers, and a plurality of sensors for vehicle stabilization and navigation, a power source, the power source is connected to a plurality of excitation terminals and providing energy to generate a net driving torque; and at least two wings, the at least two wings is coupled to shaft of the vehicle. In some embodiments, at least one motor is a direct current motor. In some aspects, the energy restoring element is a torsion spring.

### BRIEF DESCRIPTION OF THE DRAWINGS

FIG. 1 is an image of one embodiment of the present invention to achieve energy efficiency and to achieve a resonant system, involving directly driving the flapping wing using conventional direct current (DC) motors coupled with torsion springs.

FIG. 2 is a series of images showing the lifting off at various stages.

FIG. 3 is system schematic of one embodiment of the present invention.

FIG. 4 is an image of one embodiment of the present invention.

FIG. 5 is a schematic of the on board electronic system diagram.

FIG. 6 is a schematic of the function flow chart for the navigation and control system.

FIG. 7 is an image of an embodiment of the wing, specifically, a bi-stable wing.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

To avoid the drawbacks of linkage mechanisms while at the same time to achieve a resonant system, a novel resonant motor direct drive flapping wing Micro Air Vehicles (FWMAV) is disclosed. A flapping wing micro aerial system has fundamental advantages on maneuverability compared to helicopter-or-fixed-wing aerial system due to its superior ability to alter forces and torques with subtle changes in the wing kinematics. The wide range of possible changes of wing kinematics also provides versatile and effective control methods to stabilize and/or steer the motion of the vehicle in 3D space.

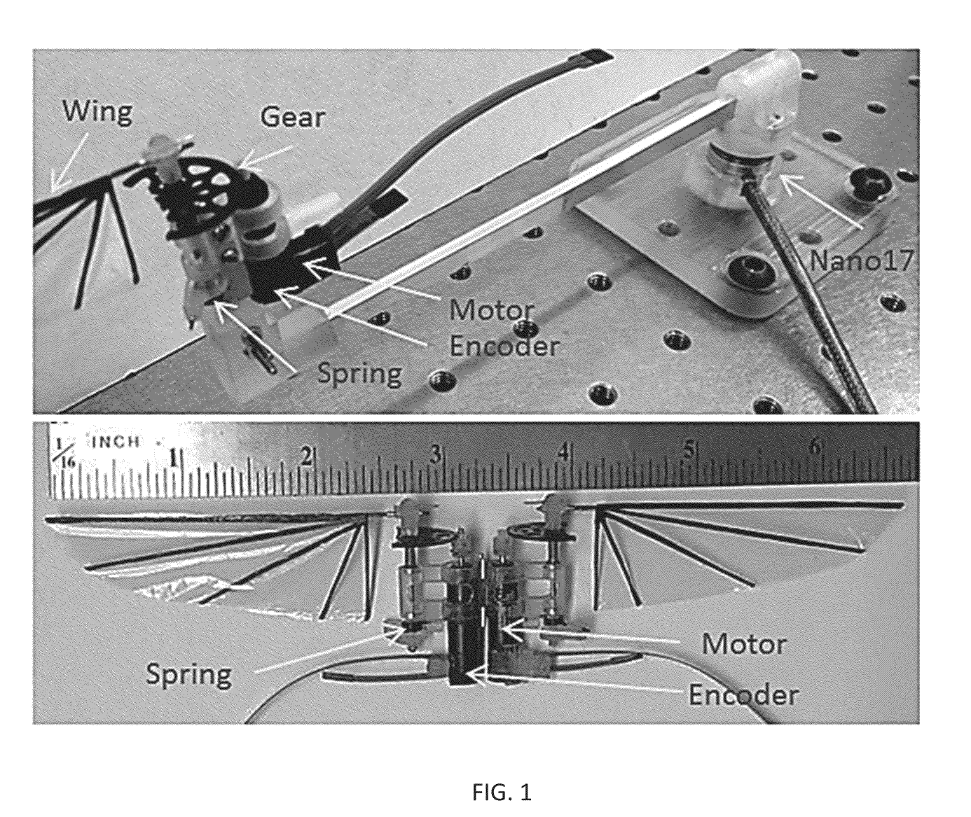

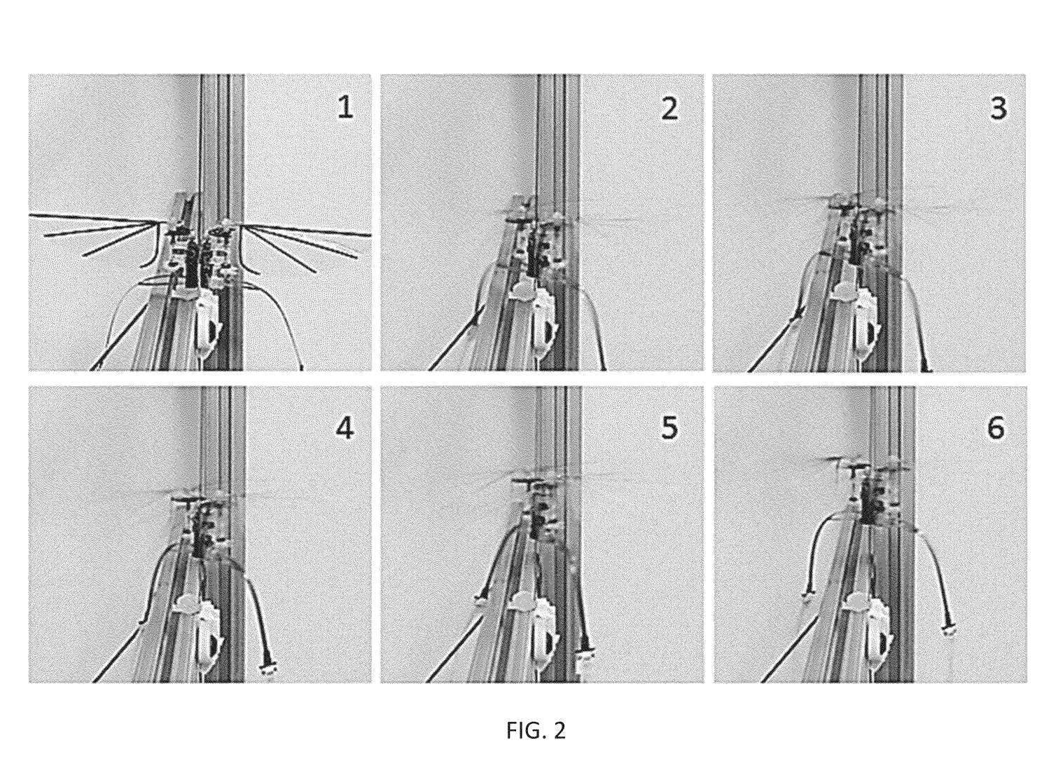

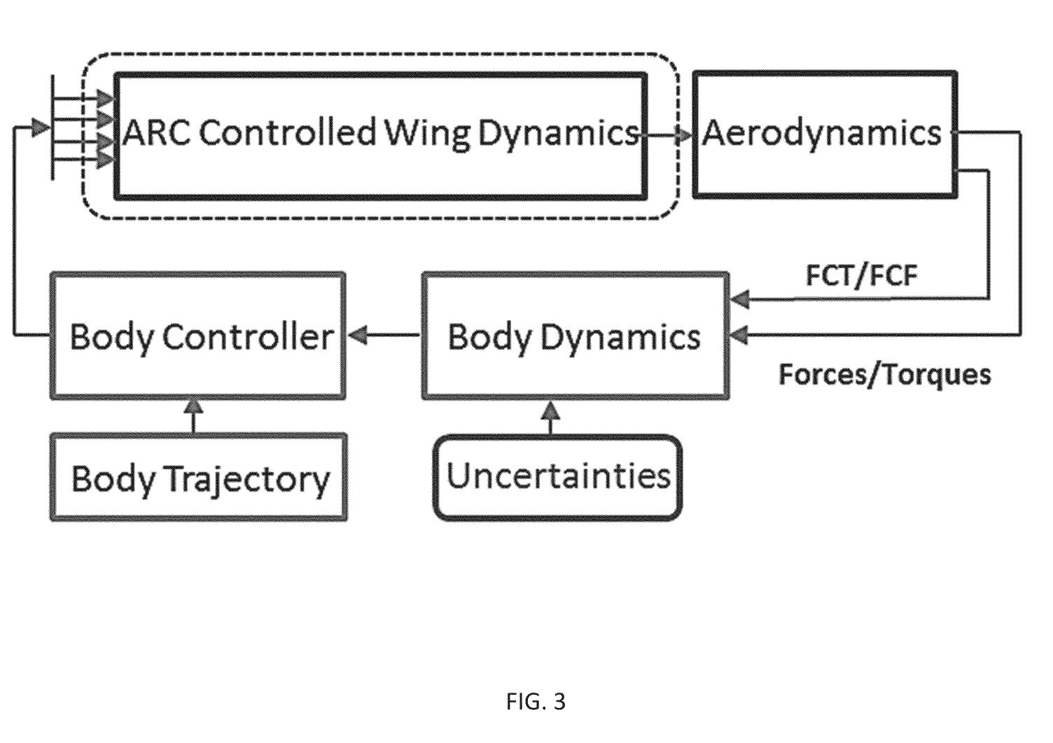

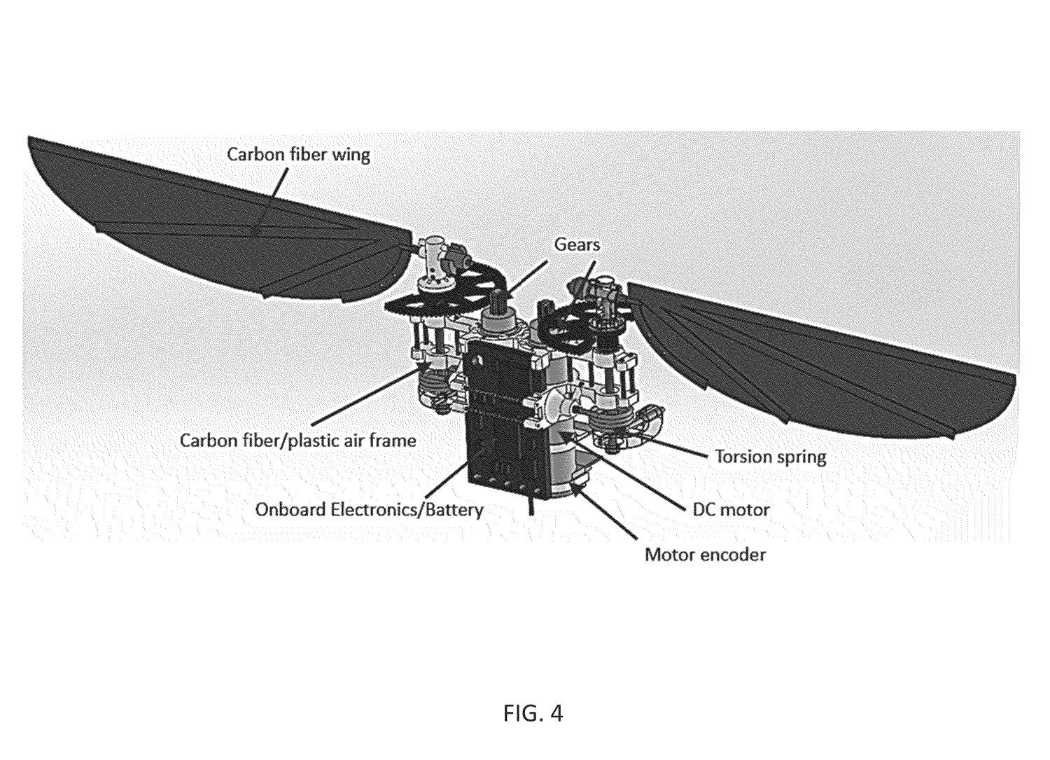

In one embodiment, for energy efficiency and to achieve a resonant system, referring to FIG. 1, we directly drive the flapping wing using conventional direct current (DC) motors coupled with torsion springs. A motor encoder may be included as well. Using a transmission gear, the motor is configured to operate at an efficient speed, but generates an overall reciprocal motion to the wing. Closed loop control is applied to achieve tracking of the desired wing motion kinematics, the frequency of which is tuned to match the resonant frequency of the system. We also show that wing kinematic control can be achieved by tracking trajectories with different amplitude and bias, therefore creating flight control forces/torques. While optimization is performed to improve the lifting ability of the system, the prototype that forms the basis of this disclosure can generate lift up to 25 grams and potential larger, depending on the size and the power of the motor. The weight of the system with onboard electronic and battery will be about 10 to about 12 grams. Referring to FIG. 2, the lifting off is shown at various stages. Each step in the stages of FIG. 2 represents 0.2 seconds. The system schematic is shown in FIG. 3. The on board control system diagram is shown in FIG. 4.

The onboard electronics include an inertial measurement unit, including one or more of the following type of sensors, such as an accelerometer, gyroscope, barometer, pressure sensor, magnetometer, compass or any other sensor that can provide angular and position information of the vehicle. The onboard electronics will also contain microcontrollers for implementation of body stabilization control algorithms, state estimation and sensor fusion algorithms, and wing kinematic control algorithms. Sensor fusion algorithms take in the reading from those onboard sensors and estimate the orientation and position of the vehicle with respect to the earth. Body stabilization control take in the orientation and position of the vehicle and control the wing flapping system to generate correction forces and torque to stabilize the system during different flight mode, such as hovering, forward flight, and other maneuvers.

The vehicle is also equipped with a power system, with primary power source from high energy density batteries, such as Lithium polymer battery, fuel cell etc. A power manage electronics are also included in the power system for management of charging, discharging, monitoring and power regeneration.

The communication system is also part of the onboard electronics. The communication system can provide communication between the vehicle and the user interface system and support functions of data transfer, manual control, etc.

The vehicle also has a vision system. The vision systems uses vision sensors, such as cameras and optical flow sensors, to take video for surveillance and to implement computer vision to aid navigation of the vehicle.

The vehicle is totally autonomous. High computation intelligent navigation algorithms are used for autonomous navigation. It can take target command for the user through communication system, and then it will plan the feasible motion and strategy to realize the command, and then it will execute the plan while autonomously avoid obstacles and navigate.

Flapping wing micro air vehicles offer superior maneuverability and response over traditional fixed wing and rotorcraft air vehicles used in conducting reconnaissance, surveillance, and search and rescue in confined or limited spaces. The performance of the herein disclosed system may be designed to function in both general consumer roles, where fabrication cost are a primary concern, and military based roles, where performance characteristics and covertness become more integral.

In another embodiment, inspired by insect wing flapping control strategy of “adaptive feedforward” and “robust feedback”, a nonlinear Adaptive and Robust controller (ARC) is designed and implemented on a direct-drive hummingbird-scale FWMAV. The experiments show ARC is able to achieve excellent tracking of various trajectories with varying amplitude, bias, frequency and split-cycle. Furthermore, good input disturbance rejection performance is experimentally demonstrated. Then system parameters are changed by swapping to a new wing with a different set of unknown parameters, the ARC shows no performance degradation with adaptation of parameters to the new values. A PID controller with model compensation is compared for benchmarking. Finally, greatly improved force control results from ARC are compared with the open loop method.

In yet another embodiment, the torsional spring can be replaced with other type of springs to provide restoring of kinetic energy, including leaf spring, flexible joint, and rotational springs. In yet another embodiment, the encoder may be removed, thus open loop control is used for wing kinematic control.

Hardware of the MAV autopilot system is presented here. The sensors are communicatively connected to the MAV's electronics. The sensor readings are collected and analyzed using algorithms, which compute useful information for the navigation system. The onboard electronic system sends out commands to drive the MAV.

The hardware architecture of autopilot system is disclosed herein. In one embodiment, referring to FIG. 1, a plurality of sensor modules 103 is placed in predetermined locations on the vehicle. The onboard electronic system 102 is physically attached onto the body of the MAV or as part of the frame structure.

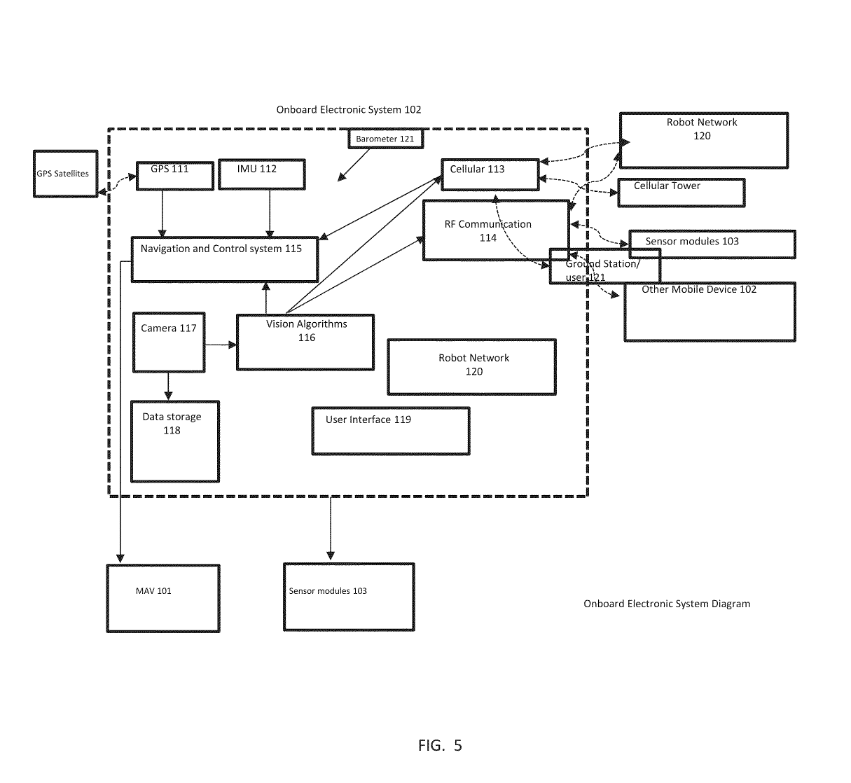

Referring to FIG. 5 for the on board electronic system diagram, in one embodiment, the onboard electronic system serves as the center of computation with its CPU, memory and data storage. It also provides sensor data acquisition for its own sensors (such as barometer, GPS, IMU, temperature and Camera) and other sensor modules 103. Sensor modules 103 include but not limited to cameras, radar, LIDAR, ultrasonic range sensors, night vision cameras, stereovision systems, laser range finder, pressure sensors, and altimeters etc, as long as their miniaturization is possible. The navigation system 115 as a software bundle running on onboard electronic system takes in the sensor readings and generates command to drive MAV 101. The onboard camera 117 records the video of the surroundings and feeds the data to either data storage 118 or upload through cellular network 113 to online storage or online website, or to the computer vision algorithms 116. The computer vision algorithms 116 provide analysis of the visional data and generate information to be used by navigation system 115. The robot network 120 provides the arena of communication among group of MAVs or between human and MAVs.

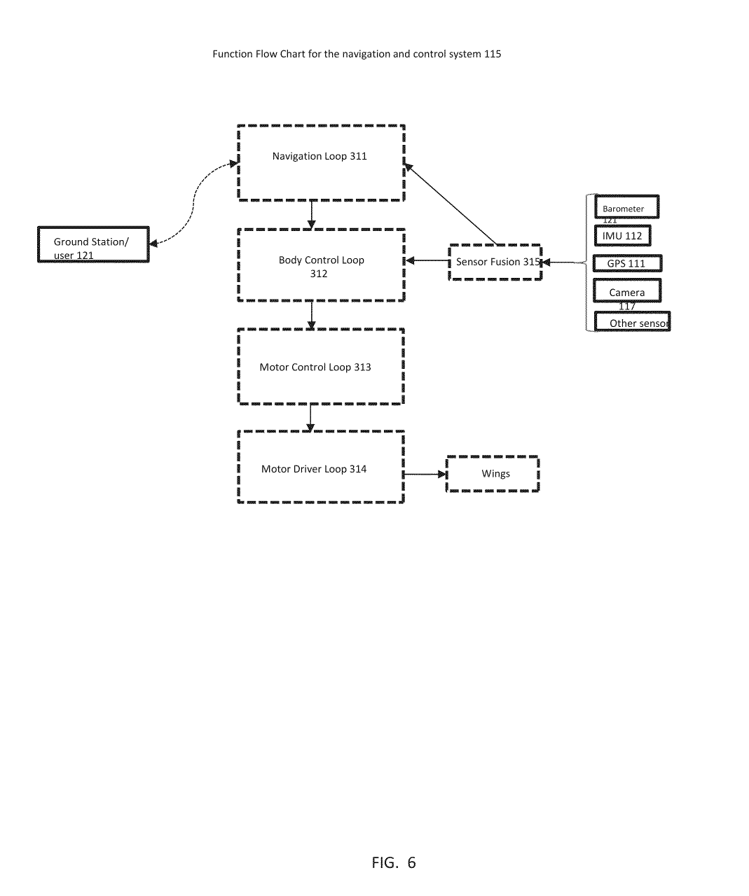

Referring to FIG. 6, the software architecture for the navigation and control system is disclosed herein. The navigation loop 311 includes three layers: a high level layer hybrid automata switching between behaviors such as task planning, artificial intelligent planning (e.g. reading in map and GPS and generating intermediary waypoints, etc.); a middle level layer hybrid automata generating trajectory and avoiding obstacle between waypoints; a low level layer trajectory tracking feedback controller. The sensor fusion 315 fuses all the sensory inputs from various onboard/off-board sensors and generate body posture estimations, position estimations, and other information about the state of the vehicle. Those information is then fed to the navigation loop 311 and body control loop 312. Body control loop 312 receives primarily body posture and position estimations, and determines the wing kinematics to control the vehicle body posture and position. The wing kinematics information is then realized by motor control loop 313. The motor driving commands are then realized by the motor drive loop 314.

For sensing, in one embodiment, onboard electronic system 102 is the center for higher-level image processing and/or computer vision algorithms and/or sensor fusion algorithms. In yet another embodiment, robust ultrasonic range sensors may be used to achieve obstacle and collision avoidance. In yet another embodiment, 3D mapping sensor, such as LIDAR is used to make high-resolution maps.

For system mapping and localization, in one embodiment, the map of for the navigation system 116 is downloaded from existing commercially available mapping services such as those from Google Map® and TomTom® for real-time navigation and traffic information. In yet another embodiment, the map is constructed along the way with onboard sensor and mapping algorithms. In yet another embodiment, Bluetooth and/or Wi-Fi and/or cellular are used for localization for the position or relative position of the MAVs. Thus formation control of MAVs is realized. In yet another embodiment, SLAM (simultaneous localization and mapping) is used to get the mapping and system location without using GPS and map services.

For communication between human and robots, in one embodiment, the robot network is used, where either existing social network such as Facebook®, twitter® and any other human online social networking methods are adopted. Thus in this embodiment, human can send command or to-do-list for the robot via online messaging, status posting, and/or hash tagging or any other existing methods that are used by human on the online social networks. The robot can do social updates using similar existing methods to messaging or update the current status via words, photos and/or videos. In another embodiment, the communications between robot and human are thought the existing methods of RF communication between robots.

For communication and networking between robots, in one embodiment, a robot social network is used, where either existing social network such as Facebook®, twitter® and any other human online social networking methods are adopted. Thus in this embodiment, robots can send command or to-do-list for the other robot via online messaging, status posting, and/or hash tagging or any other existing methods that are used by human on the online social networks. The robot can do social updates using similar existing methods to messaging or update the current status via words, photos and/or videos. In another embodiment, the communications among robots are thought Radio communication. In yet another embodiment, the communications among robots are using Bluetooth networks. In yet another embodiment, the communications among robots are using Wi-Fi networks.

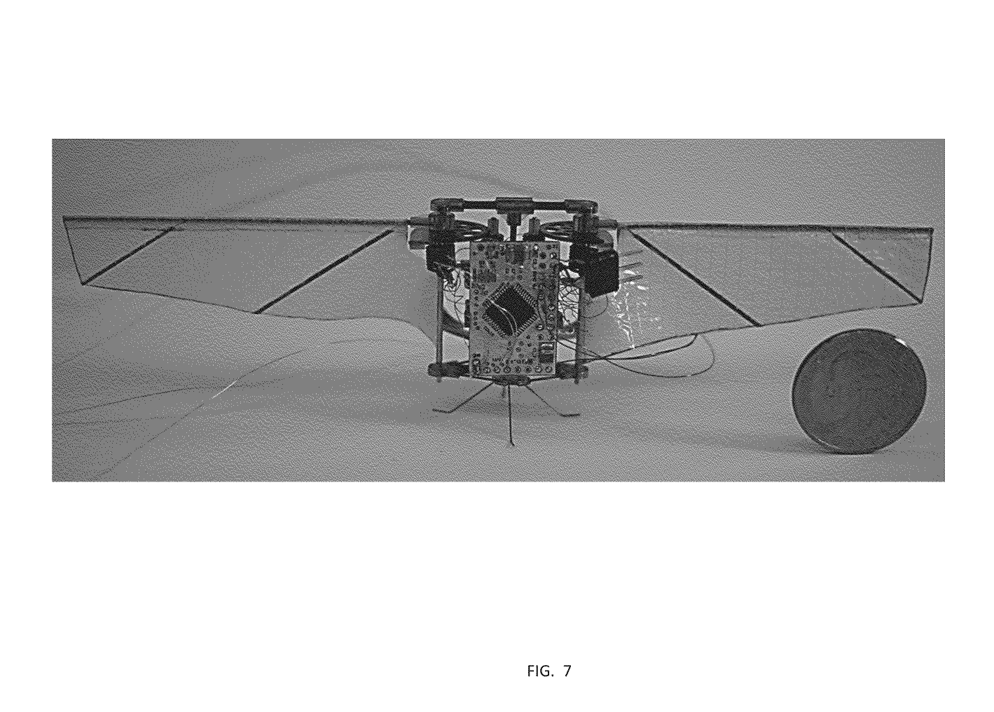

In another embodiment, the wings used are flexible, where the angle of attack is achieve through the flexible of the wing when wing loading are applied. Examples are shown in FIG. 7. This type of wing is typically called a bi-stable wing.

In another embodiment, more than two wings are used on the robot. The addition of wings (for example, three wings or four wings configurations) and their actuations can increase the payload of the vehicle.

Those skilled in the art will recognize that numerous modifications can be made to the specific implementations described above. The implementations should not be limited to the particular limitations described. Other implementations may be possible.

1. An actuation system, comprising:
a direct current motor;
a motor encoder, the motor encoder providing position feedback for the motor; and
a torsional spring, the torsional spring is coupled to the direct current motor.

2. A vehicle system, comprising:
a vehicle frame;
a rotor disposed within the vehicle frame and configured to have direct rotational oscillation about a rotation axis following a predetermined rotational arc having a middle position and operatively within a predetermined oscillation frequency range;
at least one restoring element configured to provide a net counter torque to the rotor to bias the rotor to rotate to the middle position, where the net counter torque is its minimum with the rotor's rotational position corresponds to the middle position;
at least two motors, positioned within the vehicle frame;
an onboard electronic system, the onboard electronic system comprising: an inertial measurement unit, a microcontroller, and a plurality of sensors for vehicle stabilization and navigation;
a power source, the power source connected to a plurality of excitation terminals and providing energy to generate a net driving torque; and
at least two wings, the at least two wings is coupled to shaft of the vehicle.

3. The vehicle system of claim 2, at least one motor is a direct current motor.

4. The vehicle system of claim 2, the energy restoring element is a torsion spring.
